(19) United States
(12) Patent Application Publication
(10) Pub. No.: US 2026/0349943 A1
(43) Pub. Date: Nov. 5, 2026

(54) MEMORY SYSTEM AND METHOD FOR OPTIMIZED DATA TRANSFER

(71) Applicant: Keysight Technologies, Inc., Santa Rosa, CA (US)

(72) Inventor: Geert Verbruggen, Zellik (BE)

(21) Appl. No.: 19/462,030

(22) Filed: Jan. 28, 2026

Related U.S. Application Data
(60) Provisional application No. 63/797,150, filed on Apr. 30, 2025.

(51) Int. Cl. G06F 13/28

(52) U.S. Cl. CPC G06F 13/28; G06F 2213/28

(57) ABSTRACT

A computer-implemented method is disclosed and includes specifying a source data tensor in a source memory; identifying locations of data elements to be copied; defining a destination tensor of equal or smaller size in destination memory; determining the order in which data elements are processed by a processing unit; and copying data in alignment with this order, one data unit at a time, each unit comprising elements processed simultaneously by the processing unit. A memory system having a memory layout structure for storing multidimensional tensors and a Direct Memory Access (DMA) controller is disclosed.

### CROSS-REFERENCE TO RELATED APPLICATIONS

This present application claims priority under 35 U.S.C. § 119(e) from U.S. Provisional Application 63/797,150 filed on Apr. 30, 2025. The entire disclosure of U.S. Provisional Application 63/797,150 is specifically incorporated herein by reference.

### TECHNICAL FIELD

The present teachings relate to the field of data processing systems and methods, particularly to the efficient storage, transfer, and organization of multidimensional tensor data for use in neural network inference and other computational tasks.

### BACKGROUND

Certain known memory address generators and an address increment units that includes a counter arrangement for storing and incrementing a count value until a maximum threshold is reached. Once this threshold is met, the count register resets to a start value and triggers an output signal. Additionally, the system incorporates a selector arrangement that stores candidate memory address increment values, which are selected based on the counter’s output.

Double-buffering systems with a tensor traversal unit calculate buffer memory addresses for tensor elements. Such a unit can translate tensor indices into buffer memory addresses using a base memory address and an address offset for each tensor element, determined by the tensor indices. The system supports both coarse-grained and fine-grained toggling of tensor elements in buffers, with the capability to toggle between subtensors of various group sizes for buffer memory assignment.

One known method uses descriptors to define data blocks within a data storage space, allowing each data block’s content to be determined based on the parameters of size, offset, and base address. The descriptor-driven approach allows the system to address and manage blocks within multidimensional tensor data, with parameters that indicate the shape, size, and relative positions of data blocks. According to this known method for defining and accessing N-dimensional tensor data, descriptors are used to specify each data block’s position and layout in the storage space.

Another known method for data transfer uses strided data transfer operations, where the transfer includes parameters like source and destination addresses, stride counts, stride lengths, and stride dimensions. In this known process, the stride parameters are used to advance through multidimensional data in a structured way, allowing specific sequences of data to be transferred efficiently. The method is implemented by accessing control signals that manage source block counts and stride counters to read or write data at precise, incremented memory addresses within a multidimensional tensor structure.

### SUMMARY

In a first aspect, the present teachings relate to a computer implemented method for storing neural network data elements for blockwise processing in a memory layout optimized for inference speed. The method comprises: specifying a source data tensor in a source memory; specifying a location in the source data tensor of the data elements to be copied; specifying a first memory element address and size of a destination data tensor in a destination memory, said destination data tensor of equal or smaller size than the source data tensor; determining the order in which each data element is processed by a processing unit during said blockwise processing; and copying data elements from the source tensor to the destination tensor. The step of copying data elements from the source tensor to the destination tensor is carried out taking into account said determined order, one data unit at a time, with each data unit comprising a number of data elements to be processed simultaneously by a data processing unit.

In a second aspect, the present teachings relate to a memory system for optimized data layout for blockwise processing. The memory system comprises: a memory layout structure configured to store a multidimensional tensor. The tensor comprises a plurality of data elements arranged in a first dimension, a second dimension, and a channel dimension. The memory system further comprises a Direct Memory Access (DMA) controller configured to transfer data from a source memory to a destination memory. The DMA controller comprises a descriptor defining: a source address corresponding to a first data element in the source memory, distances between subsequent data elements along the first, second, and channel dimensions in the source memory, a unit size defining the number of data elements per unit within the channel dimension to be transferred. The DMA controller is further configured to transfer data elements from the source memory to the destination memory in blocks corresponding to sub-tensors, such that: each sub-tensor is transferred to the destination memory in a contiguous block according to the memory layout structure. The data elements in each block are arranged sequentially along the channel dimension, the first dimension, and the second dimension.

The invention addresses challenges in transferring and storing multidimensional tensor data by providing a method and system designed to optimize memory layout and data movement for neural network inference and other computational tasks. The method facilitates the reorganization of tensor data from a scattered layout in the source memory to a contiguous, structured layout in the destination memory, aligning with the processing unit’s requirements. By incorporating a data-unit-based approach and dynamically adapting to the order of processing, the method enhances memory bandwidth utilization, reduces latency, and avoids runtime data reorganization. The system integrates a memory layout structure with a Direct Memory Access (DMA) controller to enable efficient blockwise transfers at the hardware level. This configuration ensures sub-tensors are stored in contiguous blocks with sequential data arrangements, improving memory access efficiency, minimizing bus contention, and reducing power consumption. Together, the method and system enhance the efficiency and performance of data processing in computational workflows.

### BRIEF DESCRIPTION OF THE DRAWINGS

The representative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 illustrates the operation of a DMA controller, showing how data is transferred from a source tensor to a destination tensor in accordance with a representative embodiment.

FIG. 2 illustrates an memory layout for a three-dimensional tensor, showing the sequential organization of data units across the X, Y, and channel dimensions in the destination memory in accordance with a representative embodiment.

### DETAILED DESCRIPTION

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms “a,” “an” and “the” are intended to include both singular and plural forms, unless the context clearly dictates otherwise. Additionally, the terms “comprises,” and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

Reference throughout this specification to "a representative embodiment" or "an embodiment" means that a particular feature, structure or characteristic described in connection with the embodiment is included in at least one embodiment of the present invention. Thus, appearances of the phrases "in one embodiment" or "in an embodiment" in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

As used herein, in addition to its ordinary and customary meaning, the term "memory layout structure" refers to the specific arrangement and organization of data elements within a memory system to optimize access and processing efficiency.

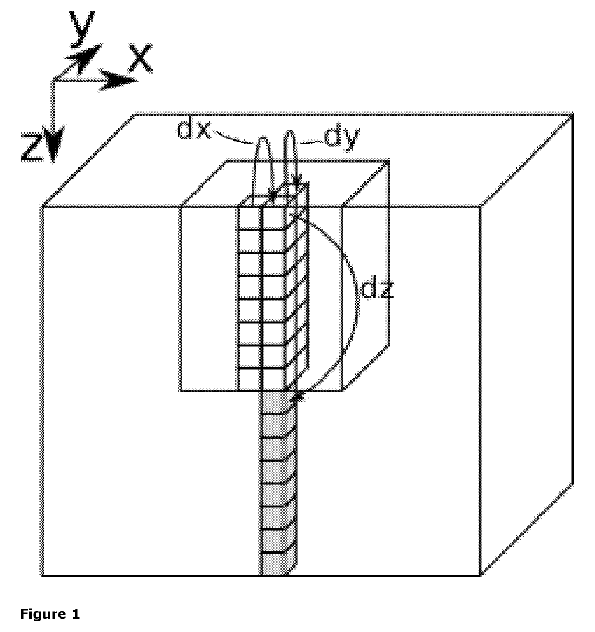

As used herein, in addition to its ordinary and customary meaning, the term "DMA controller,” which is shown and described in connection with FIG. 1 below, refers to a hardware component that autonomously manages the transfer of data between memories or devices without requiring direct intervention from the central processing unit (CPU). According to various representative embodiments described herein, the DMA controller is adapted to carry out various functions to autonomously manage the transfer of data. The DMA controller comprises the processor, which is tangible and non-transitory, and is representative of one or more processors. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor of the present teachings is an article of manufacture and/or a machine component. The processor for the DMA controller is configured to execute software instructions to perform functions as described in the various embodiments herein. The processor may be a general-purpose processor or may be part of an application specific integrated circuit (ASIC). The processor may also be (or include) a microprocessor, a microcomputer, a processor chip, a controller, a microcontroller, a digital signal processor (DSP), a state machine, or a programmable logic device. The processor may also be (or include) a logical circuit, including a programmable gate array (PGA) such as a field programmable gate array (FPGA), or another type of circuit that includes discrete gate and/or transistor logic. The processor may be a central processing unit (CPU), a graphics processing unit (GPU), or both. Additionally, the processor may comprise multiple processors, parallel processors, or both. Multiple processors may be included in, or coupled to, a single device or multiple devices.

The memory may comprise a main memory or a static memory, or both, where the memories may communicate with each other via a bus (not shown). The memory described herein are tangible storage mediums that can store data and executable instructions and are non-transitory during the time instructions are stored therein. As used herein, the term “non-transitory” is to be interpreted not as an eternal characteristic of a state, but as a characteristic of a state that will last for a period. As such, the present teachings also encompass a tangible, non-transitory computer readable medium that stores executable instructions that cause a processor or processing system to execute instructions/algorithms described herein. A tangible, non-transitory computer readable medium is defined to be any medium that constitutes patentable subject matter under 35 U.S.C. §101 and excludes any medium that does not constitute patentable subject matter under 35 U.S.C. §101. Examples of such media include non-transitory media such as computer memory devices that store information in a format that is readable by a computer or data processing system.

The term “non-transitory” specifically disavows fleeting characteristics such as characteristics of a carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As used herein, in addition to its ordinary and customary meaning, the term "data unit" refers to the smallest contiguous group of tensor elements transferred together, typically aligned with the processing capabilities of the hardware.

As used herein, in addition to its ordinary and customary meaning, the term "descriptor" refers to a structured set of parameters used by the DMA controller to define the source and destination addresses, strides, dimensions, and other attributes necessary for managing data transfers.

As used herein, in addition to its ordinary and customary meaning, the term "channel dimension" refers to the axis in a multidimensional tensor corresponding to distinct features or filters, commonly used in neural network applications.

As used herein, in addition to its ordinary and customary meaning, the term "sub-tensor" refers to a subset of a larger tensor, representing a smaller, manageable block of data used for blockwise processing.

As used herein, in addition to its ordinary and customary meaning, the term "burst memory access" refers to a method of transferring a block of contiguous data in a single transaction, improving memory transfer efficiency by reducing bus activation overhead.

As used herein, in addition to its ordinary and customary meaning, the term "three-dimensional set" refers to a representation of data organized along three distinct axes or dimensions, such as channel, first, and second dimensions, often used in tensor storage.

As used herein, in addition to its ordinary and customary meaning, the term "processing channels" refers to the parallel units within a hardware accelerator capable of performing simultaneous operations on distinct data elements or groups.

As used herein, in addition to its ordinary and customary meaning, the term "blockwise processing" refers to the division of large datasets into smaller, manageable chunks or blocks that are processed independently to optimize computational and memory usage.

The present disclosure, through one or more of its various aspects, related to a computer implemented method for storing neural network data elements for blockwise processing in a memory layout optimized for inference speed, as described more fully herein in connection with various representative embodiments.

Neural network inference tasks involve processing large multidimensional tensors, often comprising millions of elements, which must be accessed and computed in a structured manner. These tensors, typically stored in external memory, are frequently scattered across non-contiguous memory addresses due to their multidimensional nature and the constraints of common memory layouts. This scattered organization leads to inefficient memory access patterns, increased latency, and higher power consumption, especially when transferring data to internal memory optimized for processing. Furthermore, modern neural network accelerators rely on parallel processing units, which require data to be organized in a specific order and layout to maximize their computational efficiency. Without a method to align the storage and transfer of tensor data with the requirements of these accelerators, significant bottlenecks occur, such as increased memory bus contention, cache misses, and misalignment with the processing unit’s workflow. The invention addresses these challenges by introducing a method that reorganizes tensor data into an optimized memory layout, enabling efficient blockwise processing, reducing latency, and lowering power consumption, all while ensuring compatibility with the parallelized nature of modern processing units.

By specifying a source data tensor in a source memory and determining the location of the elements to be copied, the method ensures precise identification of the data relevant for processing, avoiding unnecessary memory accesses and reducing the computational overhead associated with handling large, multidimensional tensors. This focused approach improves efficiency in accessing the required portions of the source tensor, particularly in systems where memory constraints or high latency impact performance.

By specifying a destination tensor in the destination memory, including its size and first memory element address, the method allows for clear organization and preparation of the memory layout optimized for inference speed. The condition that the destination tensor is of equal or smaller size than the source tensor enables a systematic reduction in memory usage, accommodating scenarios where only a subset of the source data is required for processing. This targeted allocation minimizes wasted memory resources and ensures that the destination tensor is tailored to the processing requirements.

The step of determining the order in which each data element is processed by a processing unit provides the advantage of aligning the data transfer and memory layout with the exact requirements of the hardware accelerator. By tailoring the memory layout to match the order of processing, the method reduces unnecessary memory accesses, minimizes latency, and ensures that data is readily available in the correct sequence for computational operations. This order-based approach eliminates the need for additional reordering or buffering steps, further improving the efficiency of the data processing pipeline.

The copying of data elements from the source tensor to the destination tensor, carried out one data unit at a time, offers significant benefits. By processing data in discrete units, each comprising a number of elements that can be handled simultaneously by a data processing unit, the method optimizes the memory access patterns and ensures compatibility with the parallel processing capabilities of modern neural network accelerators. This unit-wise copying enables efficient use of memory bandwidth, reduces contention on memory buses, and facilitates burst transfers, all of which contribute to lower power consumption and faster data throughput.

The consideration of the determined order during the copying step ensures that the organization of data in the destination tensor aligns perfectly with the computational workflow. This alignment minimizes the need for costly runtime adjustments or memory reorganizations and allows the processing unit to operate at its maximum efficiency. The method's ability to maintain this alignment throughout the data transfer process is particularly advantageous for blockwise processing, where maintaining locality and minimizing cache misses are critical for achieving high inference speeds.

In an embodiment, the method comprises determining the number of available data processing channels and configuring one dimension of the destination tensor to match this number, with the direction along this dimension being the channel direction. This alignment ensures that the data layout in the destination tensor is directly compatible with the hardware's parallel processing architecture, enabling all channels to be utilized simultaneously. As a result, idle processing channels are avoided, computational throughput is maximized, and additional steps for reformatting data are eliminated. This structure reduces processing delays, lowers latency, and improves energy efficiency by minimizing unnecessary memory accesses and optimizing the flow of data to the processing unit.

In a further embodiment, each subsequent data element of a data unit is stored in an address that increments first along the channel direction, before incrementing along a second direction transversal to the channel direction. This arrangement ensures that data within the same channel slice is stored contiguously, enabling efficient burst memory access and reducing the overhead of accessing scattered memory locations. By prioritizing the channel direction, the method minimizes latency during processing, as data required for simultaneous operations across channels is readily available in sequential addresses. The subsequent increment in the transversal direction further organizes the data units into a structured layout, facilitating efficient traversal and minimizing memory access delays during blockwise processing.

In an embodiment, once a plane defined by the channel direction and the second direction of the destination tensor is filled, the subsequent data unit is stored in the next plane, starting at the lowest index position of the channel direction and the second direction. This arrangement ensures a consistent and systematic organization of data units across planes, reducing fragmentation and simplifying memory traversal. By structuring the data in discrete planes, the method facilitates efficient memory access patterns during processing, improves cache utilization, and minimizes delays caused by scattered memory accesses.

In an embodiment, each data element is a bit, and each data unit corresponds to a weight of a neural network. This configuration optimizes the memory layout for handling neural network weights, allowing efficient storage and retrieval of small, precise data elements. By grouping bits into data units, the method aligns with the parallel processing capabilities of neural network accelerators, ensuring that weights are stored compactly and accessed quickly during computations.

In an embodiment, the method includes a step of quantizing the weights of a neural network before storing the quantized weights in the destination tensor. Quantizing the weights reduces the memory footprint of the tensor, enabling the storage of more data within the same memory constraints. This step also decreases the amount of data transferred between source and destination memories, reducing latency and power consumption while maintaining sufficient precision for neural network operations.

In an embodiment, the step of specifying the location of the data elements of the source tensor to be included in the destination tensor comprises specifying a first memory element address in the source tensor and calculating the difference between the cartesian coordinates of each memory element of the destination tensor and its first memory element address. This approach allows precise mapping of data from the source tensor to the destination tensor, ensuring that the transfer process is accurate and efficient. By calculating the differences dynamically, the method eliminates the need for precomputed address mappings, reducing computational overhead and improving the flexibility of the system in handling various tensor dimensions and layouts.

In an embodiment, the step of specifying the location in the destination tensor where each data unit is stored comprises a counting procedure within a three-dimensional set consisting of the channel dimension, the second dimension, and the third dimension. The counting procedure involves counting the number of data units stored, incrementing the channel dimension by the number of processing channels per slice each time a data unit is saved, incrementing the second dimension by one while resetting the channel dimension when the channel dimension reaches the total number of channels, and incrementing the third dimension while resetting the channel and second dimensions when the second dimension reaches its maximum value and the channel dimension reaches the total number of channels. This systematic approach ensures that data units are stored in a structured and predictable manner, facilitating efficient data traversal and minimizing memory access overhead during processing.

In an embodiment, the source tensor is stored in an external memory, and the destination tensor is stored in the internal memory of an artificial intelligence accelerator. This configuration optimizes the data flow by transferring data from a high-capacity but slower external memory to a faster internal memory that is directly accessible by the processing unit. This separation allows the accelerator to perform high-speed computations without being limited by the latency of external memory access.

In an embodiment, each data unit copied from the source memory to the destination memory is copied in contiguous memory elements sized to match the width of a memory bus. This arrangement ensures that data transfers occur in burst modes, reducing the number of memory bus activations and minimizing transfer latency. By aligning data unit size with the memory bus width, the method maximizes bandwidth utilization and lowers power consumption during the data transfer process.

In an embodiment, the iteration order of transferring data elements from the source tensor to the destination tensor is varied according to the order of processing of the transferred data. This flexibility allows the transfer process to adapt to the specific requirements of the processing unit, ensuring that data is stored in a layout optimized for its intended computational workflow. By aligning the data transfer order with the processing order, the method eliminates the need for additional data reorganization, reducing computational overhead and further improving processing efficiency.

In an embodiment, the method enables dynamic adaptation to varying hardware configurations by allowing the descriptor parameters, such as the number of processing channels, slice size, and data unit size, to be modified in real time. This flexibility ensures compatibility with a wide range of hardware architectures, making the method applicable across different neural network accelerators without requiring redesigns of the data storage or transfer process. The ability to adapt to hardware variations also extends the lifespan of the method across evolving hardware standards.

In an embodiment, the method supports fault tolerance during data transfers by incorporating error-checking mechanisms when copying data units from the source tensor to the destination tensor. By validating data integrity at each step of the transfer process, the method ensures that errors introduced during transfer are detected and corrected, reducing the risk of corrupted computations. This feature is particularly advantageous in high-reliability systems where the integrity of neural network weights and inputs is critical.

In an embodiment, the method includes a feature to optimize memory usage by compressing data units prior to transfer and decompressing them upon storage in the destination tensor. This compression step reduces the bandwidth required for transferring large tensors, enabling faster transfers and lowering power consumption. Compression can be particularly beneficial for systems with limited memory or bandwidth resources.

In an embodiment, the method allows prefetching of data units during the transfer process to ensure that the processing unit has access to the required data without delays. By predicting the data access patterns based on the specified processing order, the method minimizes idle time for the processing unit and maintains a steady computational throughput. This prefetching mechanism reduces bottlenecks and improves overall system performance.

In an embodiment, the method supports multidimensional tensor slicing and reassembly during transfer. By defining subsets of the source tensor and recombining them into a different structure in the destination tensor, the method facilitates efficient manipulation of complex tensor operations, such as reshaping or permuting dimensions. This embodiment enhances the versatility of the method for various neural network architectures that require non-standard data layouts.

In an embodiment, the method includes a mechanism for prioritizing critical data units during transfer, ensuring that high-priority elements are copied and processed first. This prioritization improves responsiveness in systems where certain tensor elements are needed earlier in the computational pipeline, such as real-time inference tasks.

In an embodiment, the method incorporates support for heterogeneous processing units by allowing different slice sizes or data unit configurations to be used based on the capabilities of individual processing units. This feature enables seamless integration with heterogeneous hardware environments, such as systems combining GPUs, TPUs, and custom accelerators, optimizing performance for each component.

In an embodiment, the method allows for partial updates of the destination tensor, transferring only the portions of the source tensor that have changed. This feature reduces unnecessary data movement, further optimizing bandwidth usage and lowering power consumption in scenarios where only incremental updates to the data are required.

In a second aspect the invention pertains to a memory system for optimized data layout for blockwise processing.

The integration of a memory layout structure and a Direct Memory Access (DMA) controller, eliminates reliance on external software or manual intervention to configure or optimize data movement, enabling the system to operate autonomously across a wide range of applications. The memory layout structure, designed to dynamically adapt to varying tensor dimensions and processing requirements, ensures hardware-level independence from specific tensor layouts. This flexibility allows the system to function effectively with diverse neural network architectures without requiring predefined configurations, enhancing robustness and adaptability.

By consolidating sub-tensors into contiguous blocks directly in the destination memory, the system avoids the need for software-based reorganization after data transfer. This hardware-level consolidation streamlines the computational pipeline, reducing overall processing time and improving system responsiveness. The explicit arrangement of data elements sequentially along the channel, first, and second dimensions aligns the system naturally with three-dimensional tensor processing workflows, eliminating intermediate formatting steps typically required by conventional approaches.

The descriptor-driven operation of the DMA controller, which defines distances across dimensions and unit size, provides a lightweight yet powerful mechanism for managing frequent and high-volume tensor transfers. This structural advantage minimizes computational overhead associated with dynamic data mapping, enabling efficient handling of large-scale tensor processing. The system also enforces contiguous block transfers at the sub-tensor level, reducing latency and bus contention during memory access and ensuring that the data flow remains efficient and uninterrupted.

With its inherent scalability, the system can adapt to different neural network accelerator architectures, supporting various tensor processing requirements without being tied to any specific method or layout. The combination of the memory layout structure and DMA controller reduces the synchronization delays and resource contention typically encountered in high-throughput environments, making the system ideal for demanding computational tasks. Additionally, the native ability to perform complex memory layout transformations, such as transpositions or rotations, during data transfers without additional computational steps highlights the structural efficiency of the system. This capability further enhances its suitability for complex neural network designs and diverse machine learning applications.

### Examples and/or Description of Figures

### Example 1

The invention relates to a Direct Memory Access (DMA) controller that enables the efficient transfer of data units of a multidimensional tensor from a source memory to a destination memory. The DMA controller is designed to reorganize tensor elements, which may be scattered in the source memory, into a contiguous layout in the destination memory, optimized for blockwise processing. This process facilitates alignment with the order in which the data will be processed by a computational unit, such as those used in neural network inference tasks, ensuring efficient use of memory bandwidth and computational resources.

The controller operates based on a descriptor, which provides all necessary parameters to define both the source tensor and the destination tensor, as well as the transfer process. The descriptor includes the starting memory address of the tensor in the source memory, referred to as addrsrc, and the starting memory address in the destination memory, referred to as addrdest. It also specifies the strides, or distances, between memory addresses of subsequent elements in the X and Y dimensions in both the source and destination memories, defined as dxsrc, dysrc, dxdest, and dydest, respectively. Additionally, the descriptor includes the stride along the Z dimension, which corresponds to the channel direction, defined as dzsrc for the source memory and dzdest for the destination memory. The descriptor also specifies the size of the data units to be transferred along the X and Y dimensions, expressed as nx and ny, and the number of data units along the Z dimension, expressed as nz. The unit size, or the size in memory of a single data unit, is also specified in the descriptor, ensuring that the DMA controller can handle grouped tensor elements efficiently.

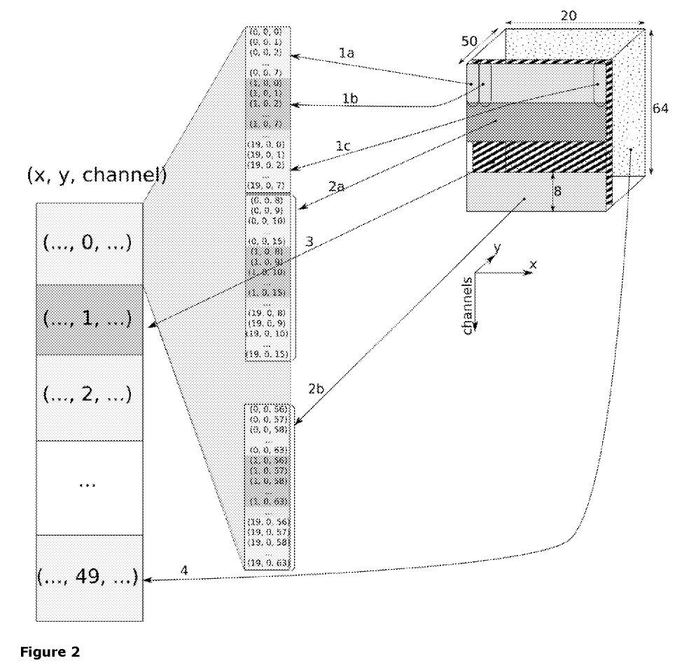

As illustrated in FIG. 2, the memory addresses for the tensor elements are calculated dynamically based on the descriptor parameters. The stride dx is defined as the memory address of an element at (x+1, y, z) minus the address of the element at (x, y, z). Similarly, dy is defined as the memory address difference between elements at (x, y+1, z) and (x, y, z). The stride dz represents the address difference between elements at (x, y, z+the number elements_per_unit) and (x, y, z). Using these strides, the memory address of an element at a specific coordinate (x, y, z) is calculated as the start address of the tensor plus x*dx + y*dy + (z/#elements_per_unit)*dz, where z must be a multiple of the number of elements per unit. In general, the address calculation can also be expressed as the memory address of the starting element plus offsets in the X, Y, and Z directions, taking into account the unit size. This ensures that data units are transferred as atomic blocks, with address calculations performed only for the start coordinates of each unit.

The transfer process is implemented in a manner that loops through the Z, Y, and X dimensions of the tensor. The pseudo-code for the process is as follows:
for z_unit in 0 to nz-1 loop
   for y in 0 to ny-1 loop
      for x in 0 to nx-1 loop
         src_addr = addrsrc + xdxsrc + ydysrc + z_unitdzsrc;
         dest_addr = addrdest + xdxdest + ydydest + z_unitdzdest;
         copy a unit from src_addr to dest_addr; end loop
      end loop;
   end loop;
end loop;

The outermost loop iterates over the z-dimension, represented by z_unit, which corresponds to slices of the tensor’s channel dimension divided into units. For each slice in the z-dimension, the second loop iterates over the y-dimension, representing rows of the tensor, and the innermost loop iterates over the x-dimension, representing columns of the tensor. For each combination of x, y, and z_unit, the source memory address ‘srcaddr‘ and destination memory address ‘destaddr‘ are dynamically calculated using the starting addresses ‘addrsrc‘ and ‘addrdest‘, along with strides ‘dxsrc‘,‘dysrc‘,‘dzsrc‘ for the source memory and ‘dxdest‘ for the destination memory. Once the addresses are determined, an entire data unit is copied from the source address to the destination address. This process is repeated systematically across all x, y, and z-dimensions until the entire tensor or sub-tensor is transferred, ensuring that the data is reorganized and stored in the destination memory according to the specified layout.

In this implementation, the Z dimension is expressed in terms of data units, simplifying address calculations and ensuring that each data unit is transferred in its entirety. This process guarantees that tensor elements scattered across the source memory are reorganized into contiguous memory blocks in the destination memory.

The optimized memory layout in the destination memory is designed to align with the computational unit’s requirements, ensuring that each data unit is stored sequentially in memory. This allows for burst access during processing and minimizes redundant memory accesses. Furthermore, the flexibility of the descriptor parameters allows for various tensor manipulations, such as transposition or subsampling, to be performed during the transfer process. This capability enhances the efficiency of tensor processing in applications such as neural network inference, where alignment between data layout and processing requirements is critical. As shown in FIG. 2, the described system ensures the systematic and efficient handling of tensor data, reducing computational latency and power consumption by optimizing memory access patterns.

### Example 2

The following example specifically addresses the arrangement and storage of a three-dimensional tensor with dimensions X, Y, and channels, as shown in FIG. 2. The tensor's dimensions are defined as Width X=20, Height Y=50, and 64 channels. This format organizes tensor elements to align with the requirements of the processing unit, which processes data in blocks referred to as "planes" in the X-channel direction.

In this memory layout, a data unit is defined as the smallest group of tensor elements stored together. A unit contains elements with identical X and Y coordinates but spanning subsequent channels. In this example, the size of each unit is 8 elements, representing 8 consecutive channels. The organization begins with all data for Y=0 stored sequentially. The plane at Y0 is divided into blocks, with each block containing 20 data units corresponding to all X-positions for the first 8 channels.

The first unit, representing data for coordinates (x=0,y=0,ch=0) to (x=0,y=0,ch=7), is stored in the initial memory locations. The second unit, containing data from (x=1,y=0,ch=0) to (x=1,y=0,ch=7) is stored immediately after the first unit. This pattern continues for all 20 X-positions, up to the 20th unit, which stores data from (x=19,y=0,ch=0) to (x=19,y=0,ch=7), as indicated by arrows 1a, 1b, and 1c in FIG. 5.

After completing the first block of 20 units, the process is repeated for the next set of 8 channels, corresponding to channels 8 to 15, as indicated by arrow 2a. This pattern continues for all remaining slices of 8 channels, up to channels 56 to 63, as shown by arrow 2b. In total, there are 64/8=8 slices for each plane. Each slice is stored contiguously in memory, ensuring optimal alignment for data processing.

Once the data for all 64 channels at Y=0 are stored, the layout proceeds to the next plane at Y=1, following the same pattern. Data for Y=1 are stored in the same order as Y=0, starting with channels 0 to 7 and proceeding through all 8 slices, as indicated by arrow 3. This process is repeated sequentially for all planes, up to the final plane at Y=49, as shown by arrow 4.

This memory layout ensures that tensor elements are stored contiguously for each slice of 8 channels, reducing the need for scattered memory accesses. Each block of data aligns with the processing unit's requirements, allowing for efficient burst memory transfers and minimizing latency. The structured approach to storing planes, slices, and units in sequential addresses optimizes both the memory layout and the computational flow, as illustrated in FIG. 1. This arrangement is particularly advantageous for neural network inference, where large tensors must be processed efficiently to meet performance and power constraints.

The present invention is in no way limited to the embodiments described in the examples and/or shown in the figures. On the contrary, methods according to the present invention may be realized in many different ways without departing from the scope of the invention.

1. A computer implemented method for storing neural network data elements for blockwise processing in a memory layout optimized for inference speed, the method comprising:
specifying a source data tensor in a source memory;
specifying a location in the source data tensor of the data elements to be copied;
specifying a first memory element address and size of a destination data tensor in a destination memory, said destination data tensor of equal or smaller size than the source data tensor;
determining the order in which each data element is processed by a processing unit during said blockwise processing; and
copying data elements from the source tensor to the destination tensor, wherein the copying data elements from the source tensor to the destination tensor is carried out taking into account said determined order, one data unit at a time, each data unit comprising a number of data elements to be processed simultaneously by a data processing unit.

2. The method according to claim 1, further comprising determining the number of available data processing channels, wherein one of the dimensions of the destination tensor is equal to the number of available processing channels, the direction along said dimension being the channel direction.

3. The method according to claim 2, wherein the processing channels are grouped in slices, each slice having a number of channels equal to the number of data elements in a data unit.

4. The method according to any of the claim 3, wherein each subsequent data element of each data unit is first stored in an address incrementing along the channel direction, before incrementing said address in a second direction transversal to the channel direction.

5. The method according to claim 4, wherein once a plane defined by the channel direction and the second directions of the destination tensor is filled, the subsequent data unit is stored in a subsequent plane, starting at a lowest index position of the channel direction and second direction.

6. The method according to claim 5, wherein each of the data elements is a bit and each unit corresponds to a weight of a neural network.

7. The method according to claim 6, further comprising quantizing the weights of a neural network before storing the quantized weights in the destination tensor.

8. The method according to claim 1, wherein the specifying the location of the data elements of the source tensor to be included in the destination tensor comprises:
specifying a first memory element address in the source tensor; and
calculating the difference between the cartesian coordinates of each memory element of the destination tensor and its first memory element address.

9. The method according to claim 1, wherein the specifying the location in the destination tensor where each data unit is stored comprises a counting procedure, said destination being a three dimensional set comprising the channel dimension, the second dimension and the third dimension, the counting procedure comprising:
counting a number of data units stored;
incrementing the channel dimension by a number equal to the number of processing channels per slice each time a data unit is saved;
incrementing the second dimension by one and resetting the channel dimension each time the channel dimension reaches a number equal to the total number of channels; and
incrementing the third dimension by one, and resetting channel dimension and second dimension each time said second dimension reaches its maximum value and the channel dimension reaches a number equal to the total number of channels.

10. The method according to claim 1, wherein the source tensor is stored in an external memory, and the destination tensor is stored in an internal memory of an artificial intelligence accelerator.

11. The method according to claim 1, wherein each data unit copied from the source memory to the destination memory is copied in contiguous memory elements sized to match the width of a memory bus.

12. The method to claim 1, wherein an iteration order of transferring data elements from source to destination is varied according to the order of processing of said transferred data.

13. A memory system adapted to provide an optimized data layout for blockwise processing, comprising:
a memory layout structure configured to store a multidimensional tensor, wherein the tensor comprises a plurality of data elements arranged in a first dimension, a second dimension, and a channel dimension;
a Direct Memory Access (DMA) controller configured to transfer data from a source memory to a destination memory, wherein the DMA controller comprises a descriptor defining:
a source address corresponding to a first data element in the source memory,
distances between subsequent data elements along the first, second, and channel dimensions in the source memory,
a unit size defining the number of data elements per unit within the channel dimension to be transferred;
wherein the DMA controller is further configured to transfer data elements from the source memory to the destination memory in blocks corresponding to sub-tensors, such that:
each sub-tensor is transferred to the destination memory in a contiguous block according to the memory layout structure; and
the data elements in each block are arranged sequentially along the channel dimension, the first dimension, and the second dimension.

14. A tangible, non-transitory computer readable medium that stores machine executable instructions, which when executed by a processor, cause the processor to:
specify a source data tensor in a source memory;
specify a location in the source data tensor of the data elements to be copied;
specify a first memory element address and size of a destination data tensor in a destination memory, said destination data tensor of equal or smaller size than the source data tensor;
determine an order in which each data element is processed by a processing unit during said blockwise processing; and
copying data elements from the source tensor to the destination tensor, wherein the copying data elements from the source tensor to the destination tensor is carried out taking into account said determined order, one data unit at a time, each data unit comprising a number of data elements to be processed simultaneously by a data processing unit.

15. The tangible, non-transitory computer readable medium according to claim 1, wherein the instructions further cause the processor to determine the number of available data processing channels, wherein one of the dimensions of the destination tensor is equal to the number of available processing channels, the direction along said dimension being the channel direction.

16. The tangible, non-transitory computer readable medium according to claim 15, wherein the processing channels are grouped in slices, each slice having a number of channels equal to the number of data elements in a data unit.

17. The tangible, non-transitory computer readable medium according to any of the claim 16, wherein each subsequent data element of each data unit is first stored in an address incrementing along the channel direction, before incrementing the address in a second direction transversal to the channel direction.

18. The tangible, non-transitory computer readable medium according to claim 17, wherein once a plane defined by the channel direction and the second directions of the destination tensor is filled, the subsequent data unit is stored in a subsequent plane, starting at a lowest index position of the channel direction and second direction.

19. The tangible, non-transitory computer readable medium according to claim 18, wherein each of the data elements is a bit and each unit corresponds to a weight of a neural network.

20. The tangible, non-transitory computer readable medium according to claim 14, wherein when specifying the location of the data elements of the source tensor to be included in the destination tensor, the instructions further cause the processor to:
specify a first memory element address in the source tensor; and
calculate the difference between the cartesian coordinates of each memory element of the destination tensor and its first memory element address.
